(19) United States
(12) Patent Application Publication
(10) Pub. No.: US 2010/0306492 A1
(43) Pub. Date: Dec. 2, 2010

(54) Relay device and relay program

(75) Inventors: Tetsuya Kinoshita, Kawasaki (JP); Toshiaki Takeuchi, Kawasaki (JP); Masakazu Sakamoto, Kawasaki (JP); Takuya Kurihara, Kawasaki (JP); Jun Takeuchi, Kawasaki (JP); Atsushi Shinohara, Kawasaki (JP); Yusuke Kurasawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/663,000

(22) Filed: May 14, 2010

(30) Foreign Application Priority Data
Jun. 1, 2009 (JP) 2009-132488

(51) Int. Cl. G06F 12/02

(52) U.S. Cl. 711/165; 711/E12.002

(57) ABSTRACT

Relay devices each include a port connected to a communication channel that is used to transfer and receive an access request to and from another relay device; a first virtual area section that is set as a virtual memory area that receives an access request; and a second virtual area section set as a virtual memory area for receiving an access request transferred from another relay device. The relay device sends, if a channel to a storage device is in operation, the access request that is sent to the first virtual area section and the access request that is sent to the second virtual area section, to the storage device via the channel. The relay device transfers, if the channel is not in operation, the access request sent to the first virtual area section, to another relay device via the communication channel connected to the port.

### CROSS-REFERENCE TO RELATED APPLICATION

This application is based upon and claims the benefit of priority of the prior Japanese Patent Application No. 2009-132488, filed on Jun. 1, 2009, the entire contents of which are incorporated herein by reference.

### FIELD

The embodiments discussed herein are directed to a relay device and a relay program.

### BACKGROUND

In recent years, storage virtualization systems in which memory areas are flexibly allocated by virtualizing storage have been introduced. Various methods are used for the storage virtualization. For example, a method in which configuration information and paths related to virtually allocated memory areas are set in relay devices that are arranged between a host computer and a physical storage device has been disclosed.

The storage virtualization system is sometimes configured in a redundant manner by aiming at load distribution or high reliability. For example, as illustrated in FIGS. 8A to 10, the storage virtualization systems make virtualization switches, serving as relay devices, redundant. In such a case, the host computer is equipped with a multipath driver and performs a multipath control on paths that are formed between the virtualization switches. FIGS. 8A to 10 are schematic diagrams explaining the conventional technologies.

Furthermore, recently, storage devices may have, in some cases, redundant paths. As illustrated in FIGS. 8A to 8C, 9 and 10, the storage devices have, for example, active paths corresponding to channels that are currently in operation (paths indicated by the solid line in FIGS. 8A to 8C, 9 and 10) and passive paths corresponding to channels that are not currently in operation (paths indicated by the dotted line in FIGS. 8A to 8C, 9 and 10).

In such a case, the storage device performs, for example, as illustrated in FIGS. 8A and 8B, a process by switching paths in accordance with access requests received from the host computer. Furthermore, when switching paths, the storage device sends an error reply to the host computer. Specifically, when the storage device receives an access request as illustrated in FIG. 8A and then receives another access request as illustrated in FIG. 8B, the storage device switches paths after sending an error reply to the host computer.

Such conventional technologies are disclosed in for example Japanese Laid-open Patent Publications No. 2008-112399 and No. 2005-242982.

However, with the conventional technology, frequent switching of the paths occurs in the storage device, whereby there is a problem of reduction in the performance of the storage virtualization system. Specifically, for example, as illustrated in FIG. 8C, as a result of a multipath control performed by the host computer, if access requests from the host computer are randomly sent to both paths, the storage device needs to switch the paths by performing an error reply each time. This causes the frequent occurrence of error replies, whereby the access requests themselves are sometimes recognized as errors due to the paths being blocked.

Furthermore, the above described problem is not limited to the multipath control performed by the host computer. For example, as illustrated in FIG. 9, when the storage device performs copying processing using an active path, if an access request from the host computer is sent to the passive path, frequent switching of the paths occurs in the storage device, whereby the copying processing itself may become errors. Furthermore, for example, as illustrated in FIG. 10, in a virtualization switch, a concatenation-type virtual volume is assumed to be set in which a real disk volume that is connected to the active path and a real disk volume that is connected to the passive path are virtually coupled to each other. If access requests from the host computer are sent to a memory area in a real disk volume 1 or to a memory area in a real disk volume 2, frequent switching of the paths occurs in the storage device, whereby the access requests themselves may become errors.

### SUMMARY

According to an aspect of an embodiment of the invention, a relay device is connected between a host computer and a storage device, and is configured to allocate, using a real memory area included in the storage device, a virtual memory area to the host computer, and to process an access request to the virtual memory area. The relay device includes a port connected to a communication channel for transferring and receiving an access request to and from another relay device; a first virtual area section set as a virtual memory area for receiving an access request from the host computer; a second virtual area section connected to the communication channel via the port and set as a virtual memory area for receiving an access request transferred from the another relay device; and a control unit that sends, if a channel to the storage device is in operation, the access request that is sent to the first virtual area section and the access request that is transferred to the second virtual area section, to the storage device via the channel, the control unit transferring, if the channel is not in operation, the access request that is sent to the first virtual area section, to the another relay device via the communication channel that is connected to the port.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram explaining a storage virtualization system according to a first embodiment;

FIG. 2 is a schematic diagram explaining a storage virtualization system according to a second embodiment;

FIG. 3 is a schematic diagram explaining the storage virtualization system according to the second embodiment;

FIG. 4 is a block diagram illustrating the configuration of a virtualization switch;

FIG. 5A is a table explaining configuration information contained in a virtualization switch A;

FIG. 5B is a table explaining configuration information contained in a virtualization switch B;

FIG. 6 is a flowchart illustrating the flow of a process performed by a storage virtualization unit;

FIG. 7 is a flowchart illustrating the flow of a process performed by an inter-switch zoning unit;

FIGS. 8A to 8C are schematic diagrams explaining a conventional technology;

FIG. 9 is a schematic diagram explaining a conventional technology; and

FIG. 10 is a schematic diagram explaining a conventional technology.

### DESCRIPTION OF EMBODIMENTS

Preferred embodiments of the present invention will be explained with reference to accompanying drawings.

The present invention is not limited to the embodiment described below.

### [a] First Embodiment

### Storage Virtualization System According to First Embodiment

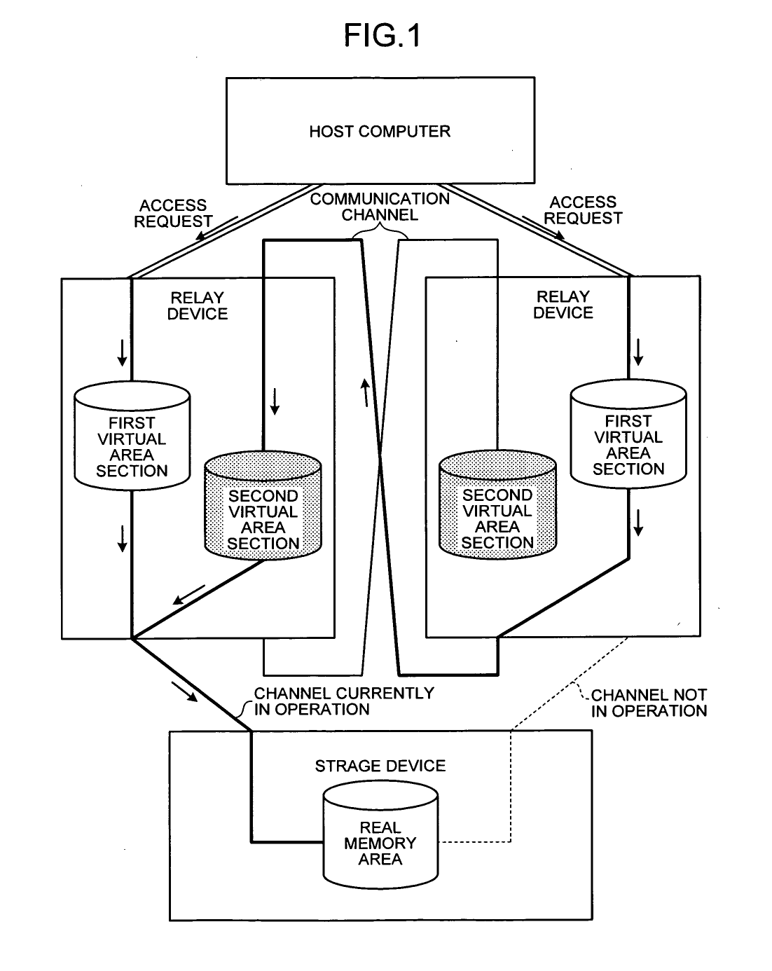

First, a storage virtualization system according to a first embodiment will be described with reference to FIG. 1. FIG. 1 is a schematic diagram explaining the storage virtualization system according to the first embodiment.

As illustrated in FIG. 1, the storage virtualization system according to the first embodiment includes relay devices that are connected between a host computer and a storage device, that allocate, using a real memory area included in a storage device, virtual memory areas to the host computer, and that process access requests to virtual memory areas.

As illustrated in FIG. 1, the relay devices each have ports that are connected to communication channels used to transfer, between relay devices, access requests to another relay device.

Furthermore, as illustrated in FIG. 1, the relay devices each have a first virtual area section and a second virtual area section. The first virtual area section is set in the relay device as a virtual memory area that receives access requests from the host computer. The second virtual area section is set in the relay device as a virtual memory area that receives access requests transferred from the other relay device. As illustrated in FIG. 1, the second virtual area section is connected to the communication channel via the ports.

Furthermore, as illustrated in FIG. 1, the relay devices each perform a control in accordance with whether channels to the storage device are in operation.

For example, in the relay device illustrated on the left side of FIG. 1, the channel to the storage device is in operation. Accordingly, the relay device performs a control in such a manner that an access request sent from the host computer to the first virtual area section and an access request transferred from the other relay device to the second virtual area section are sent to the storage device via a channel that is in operation.

In contrast, for example, in the relay device illustrated on the right side of FIG. 1, the channel to the storage device is not in operation. Accordingly, the relay device performs a control in such a manner that an access request sent to the first virtual area section is transferred to the other relay device via a communication channel connected to the port.

### Advantage of First Embodiment

As described above, the storage virtualization system according to the first embodiment transfers, using the communication channels arranged between the relay devices, access requests, issued to the virtual area sections, that are distributed and sent to the relay devices and sends the access requests from the relay device whose channel is in operation to the storage device. Therefore, according to the first embodiment, it is possible to reduce the frequency of switching paths in the storage device, thus improving the performance of the storage virtualization system.

### [b] Second Embodiment

In the following, a storage virtualization system according to a second embodiment will be described. In the second embodiment, a storage virtualization system will be described that includes a “virtualization switch”, which is an example of a relay device, and also includes a host computer and a storage device.

### Storage Virtualization System According to the Second Embodiment

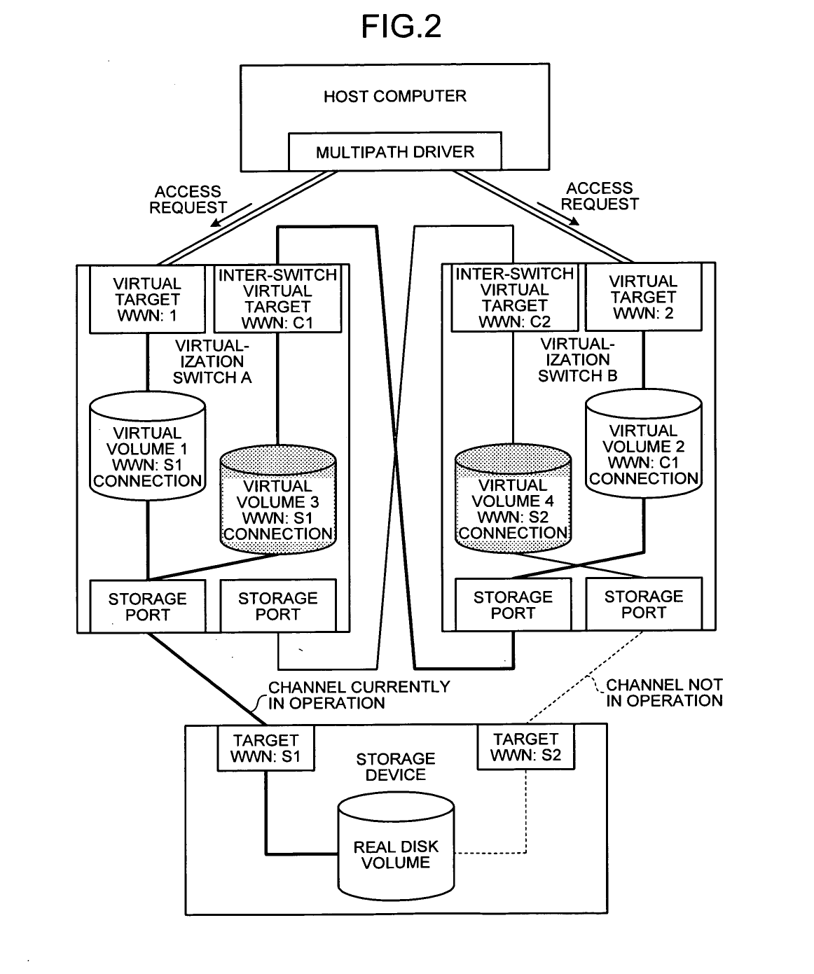

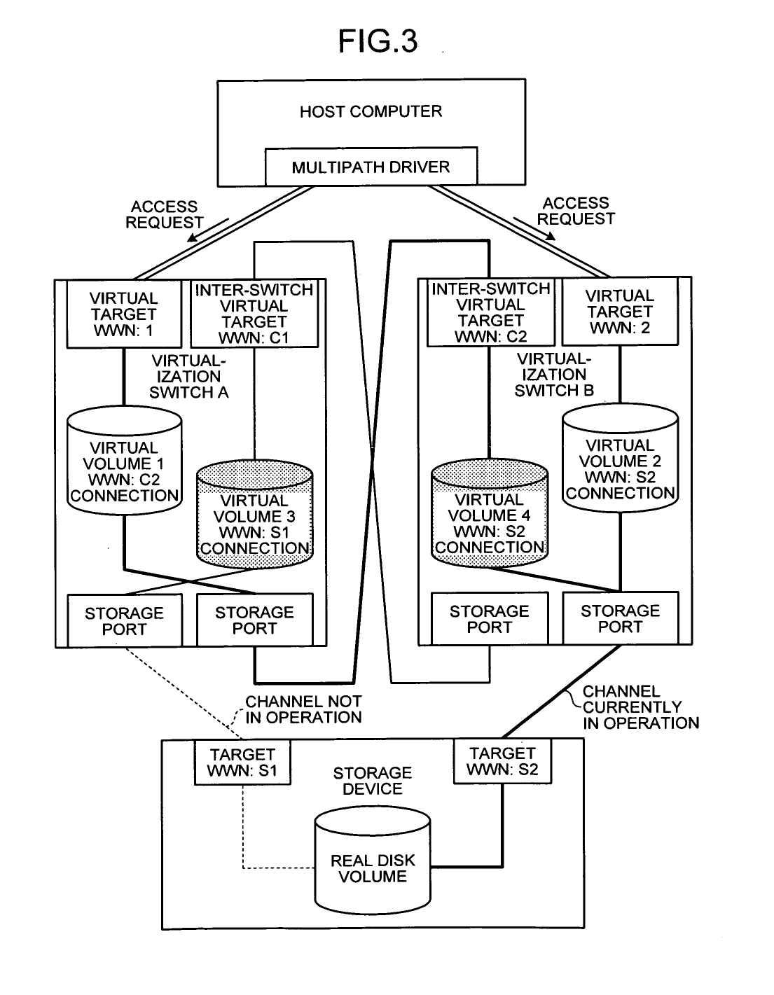

First, the storage virtualization system according to the second embodiment will be described with reference to FIGS. 2 and 3. FIGS. 2 and 3 are schematic diagrams explaining the storage virtualization system according to the second embodiment.

As illustrated in FIG. 2, in the storage virtualization system according to the second embodiment, virtualization switches are connected between a host computer and a physical storage device, and the virtualization switches implement storage virtualization. Furthermore, as illustrated in FIG. 2, the storage virtualization system according to the second embodiment makes the virtualization switches redundant. Specifically, the host computer is equipped with a multipath driver and performs a multipath control in such a manner that loads are distributed to a redundant virtualization switch A and a redundant virtualization switch B.

In the storage virtualization system according to the second embodiment, the storage device has redundant paths. Specifically, the storage device has a channel that is currently in operation and a channel that is not currently in operation, which are serving as channels accessing a real disk volume. In FIGS. 2 and 3, the channel that is currently in operation (active path) is indicated by the solid line, and the channel that is not currently in operation (passive path) is indicated by the dotted line. In FIG. 2, the channel between the virtualization switch A and the storage device is currently in operation (active path), and the channel between the virtualization switch B and the storage device is not currently in operation (passive path). In contrast, in FIG. 3, the channel between the virtualization switch A and the storage device is not currently in operation (passive path), and the channel between the virtualization switch B and the storage device is currently in operation (active path).

In the storage virtualization system according to the second embodiment, the virtualization switches store therein configuration information and paths related to virtually allocated memory areas in a real disk volume in the storage device (hereinafter, “virtual volume”). The host computer implements an access to the real disk volume by accessing virtual volumes that are set in the virtualization switches.

Specifically, the host computer implements an access to the real disk volume by sending an access request to a “virtual target” that is set in a virtualization switch. For example, as illustrated in FIG. 2, the virtualization switch A according to the second embodiment creates a “WWN (world wide name): 1” as the virtual target that is used to access a virtual volume 1 and sets a path that couples the “WWN: 1” to the virtual volume 1. Furthermore, the virtualization switch A sets a path that couples the virtual volume 1 to a target “WWN: S1” in the real disk volume. By doing so, an access request, which is issued to access the virtual volume 1, sent from the host computer to the “WWN: 1” is sent to the real disk volume.

With this configuration, the virtualization switches according to the second embodiment set virtual volumes and paths in a manner described below so as to reduce the frequency of switching paths in the storage device and improve the performance of the storage virtualization system.

Specifically, as illustrated in FIG. 2, regarding the virtualization switches according to the second embodiment, the virtualization switch A sets a virtual volume 3, in addition to setting the virtual volume 1, as a memory area that is accessed by the host computer. In contrast, as illustrated in FIG. 2, the virtualization switch B sets a virtual volume 4, in addition to setting a virtual volume 2, as a memory area that is accessed by the host computer.

The virtual volume 3 is a virtual volume corresponding to the virtual volume 2 that is set in the virtualization switch B, whereas the virtual volume 4 is a virtual volume corresponding to the virtual volume 1 that is set in the virtualization switch A.

Specifically, as illustrated in FIG. 2, the virtualization switch A and the virtualization switch B create a “WWN: C1” and a “WWN: C2”, respectively, as “inter-switch virtual targets” that are used to access each other's the virtualization switches. Furthermore, as illustrated in FIG. 2, the virtualization switch A couples the virtual volume 3 to the “WWN: C1” and to a storage port that is connected to a target “WWN: S1” in the storage device. The virtualization switch B couples the virtual volume 4 to the “WWN: C2” and to a storage port that is connected to a target “WWN: S2” in the storage device.

As illustrated in FIG. 2, if the channel between the virtualization switch A and the storage device is currently in operation (active path), the virtualization switch A controls the virtual volume 1 to couple the virtual volume 1 to the storage port. Furthermore, the virtualization switch B controls the virtual volume 2 to couple the virtual volume 2 to the storage port that is connected to the “WWN: C1”. By doing so, access requests sent from the host computer to the virtual volume 2 are transferred to the virtual volume 3.

In other words, no matter whether the access requests from the host computer are sent to the virtual volume 1 or sent to the virtual volume 2, all of the access requests are sent to the virtualization switch A. Then, the virtualization switch A transfers all of the access requests to the storage device using the active path. As a result, no switching of the paths occurs in the storage device no matter in what way the multipath control is performed by the host computer.

In contrast, as illustrated in FIG. 3, if the channel between the virtualization switch B and the storage device is currently in operation (active path), the virtualization switch B controls the virtual volume 2 to couple the virtual volume 2 to the storage port. Furthermore, the virtualization switch A controls the virtual volume 1 to couple the virtual volume 1 to the storage port that is connected to the “WWN: C2”. By doing so, access requests sent from the host computer to the virtual volume 1 are transferred to the virtual volume 4.

In other words, no matter whether the access requests from the host computer are sent to the virtual volume 1 or sent to the virtual volume 2, all of the access requests are sent to the virtualization switch B. Then, the virtualization switch B transfers all of the access requests to the storage device using the active path. As a result, no switching of the paths occurs in the storage device no matter in what way the multipath control is performed by the host computer.

In this way, the virtualization switch A and the virtualization switch B set virtual volumes and paths in such a manner that access requests sent to the target virtual volume are transferred to the channel that is currently in operation without being affected by the multipath control performed by the host computer. Accordingly, it is possible to reduce the frequency of switching paths in the storage device, thus improving the performance of the storage virtualization system.

### Configuration of the Virtualization Switch According to the Second Embodiment

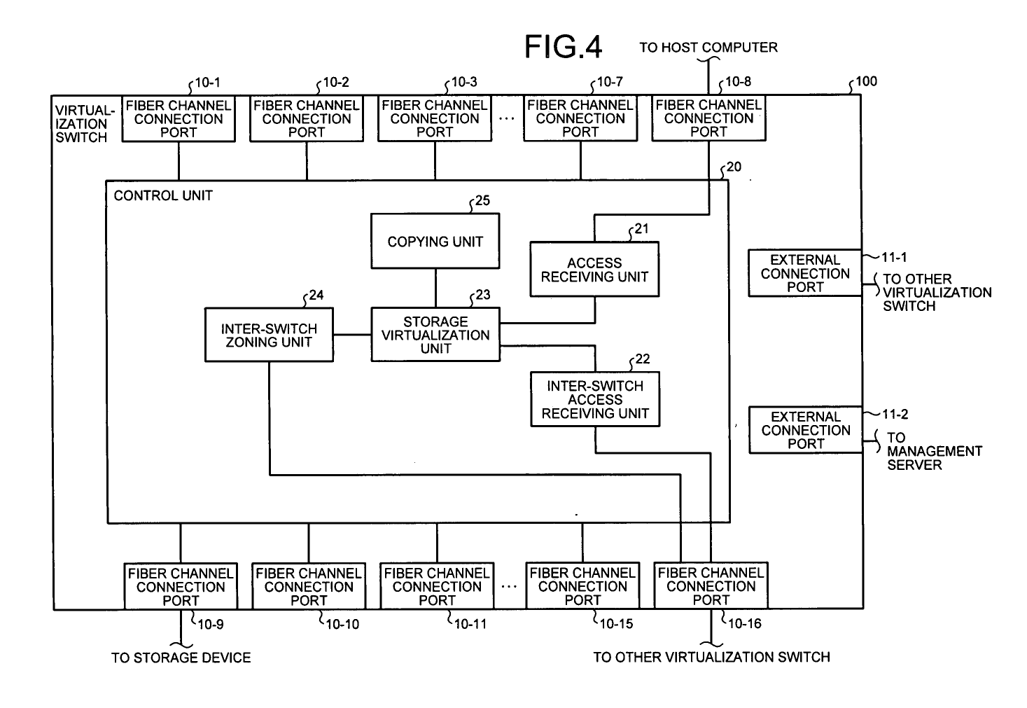

In the following, the configuration of the virtualization switch according to the second embodiment will be described with reference to FIG. 4. FIG. 4 is a block diagram illustrating the configuration of the virtualization switch. The virtualization switch A and the virtualization switch B illustrated in FIGS. 2 and 3 have the same configuration. Therefore, in the following, the configuration of the virtualization switch A and the virtualization switch B will be described using a virtualization switch 100.

As illustrated in FIG. 4, the virtualization switch 100 according to the second embodiment mainly includes fiber channel connection ports 10 (10-1 to 10-16), external connection ports 11 (11-1 and 11-2), and a control unit 20. As illustrated in FIG. 4, the control unit 20 principally includes an access receiving unit 21, an inter-switch access receiving unit 22, a storage virtualization unit 23, an inter-switch zoning unit 24, and a copying unit 25.

The fiber channel connection ports 10 are interfaces for connecting the virtualization switch 100 to another device using fiber channels. Specifically, the fiber channel connection ports 10 are connected to another device via fiber channel cables (for example, coaxial cables and optical-fiber cables). For example, the fiber channel connection ports 10 are connected to the host computer, the other virtualization switch 100, or the storage device. In the second embodiment, a case in which the virtualization switch 100 has a total of 16 ports (10-1 to 10-16) for the fiber channel connection ports 10 is described as an example; however, the configuration is not limited thereto. The number of ports thereof can be arbitrarily changed according to the size of the virtualization switch 100.

The external connection ports 11 are interfaces for connecting the virtualization switch 100 to another device using an Ethernet (registered trademark). Specifically, the external connection ports 11 are connected to another device via Ethernet (registered trademark) cables. For example, the external connection ports 11 are connected to the other virtualization switch 100 or a management server that manages the virtualization switch 100. In the second embodiment, a case in which the virtualization switch 100 has a total of two ports (11-1 and 11-2) for the external connection ports 11 is described as an example; however, the configuration is not limited thereto. The number of ports thereof can be arbitrarily changed according to the size of the virtualization switch 100.

The control unit 20 has a central processing unit (CPU), a read only memory (ROM), a large scale integrated (LSI) circuit, and the like. Specifically, the control unit 20 implements functions of each unit described below by executing, in the CPU or using the LSI circuit, firmware programs stored in the ROM.

The access receiving unit 21 receives an access request sent from the host computer. Specifically, the access receiving unit 21 is connected to the fiber channel connection port 10 and the storage virtualization unit 23; receives, via the fiber channel connection port 10, an access request sent from the host computer; and transfers the received access request to the storage virtualization unit 23. For example, in the virtualization switch 100 illustrated in FIG. 4, by way of an example, the fiber channel connection port 10-8 is connected to the host computer. Accordingly, the access receiving unit 21 receives an access request via the fiber channel connection port 10-8.

Here, the virtualization switch 100 is assumed to be the virtualization switch A illustrated in FIGS. 2 and 3. As illustrated in FIGS. 2 and 3, the virtualization switch A sets the “virtual volume 1” as a virtual area, which is presented to the host computer. Accordingly, the host computer sends an access request issued to the “virtual volume 1” to the virtualization switch A. Specifically, the access receiving unit 21 in the virtualization switch A receives the access request issued to the virtual target “WWN: 1” from the host computer and transfers it to the storage virtualization unit 23.

In contrast, the virtualization switch 100 is assumed to be the virtualization switch B illustrated in FIGS. 2 and 3. As illustrated in FIGS. 2 and 3, the virtualization switch B sets the “virtual volume 2” as a virtual area, which is presented to the host computer. Accordingly, the host computer sends an access request issued to the “virtual volume 2” to the virtualization switch B. Specifically, the access receiving unit 21 in the virtualization switch B receives the access request issued to the virtual target “WWN: 2” from the host computer and transfers it to the storage virtualization unit 23.

The inter-switch access receiving unit 22 receives an access request that is sent from the other virtualization switch 100. Specifically, the inter-switch access receiving unit 22 is connected to the fiber channel connection port 10 and the storage virtualization unit 23; receives an access request sent from the other virtualization switch 100 via the fiber channel connection port 10; and transfers the received access request to the storage virtualization unit 23. For example, in the virtualization switch 100 illustrated in FIG. 4, by way of an example, the fiber channel connection port 10-16 is connected to the other virtualization switch 100. Accordingly, the inter-switch access receiving unit 22 receives an access request via the fiber channel connection port 10-16.

Here, the virtualization switch 100 is assumed to be the virtualization switch A illustrated in FIGS. 2 and 3. As illustrated in FIGS. 2 and 3, the virtualization switch A sets the “virtual volume 3” as an external virtual volume corresponding to the “virtual volume 2” that is set in the virtualization switch B. The external virtual volume mentioned here means a virtual volume that is set, in the other virtualization switch, as a transfer destination for an access request with respect to a virtual volume that is set in its own virtualization switch, i.e., the external virtual volume means an external virtual volume that is set in a virtualization switch other than its own virtualization switch. Furthermore, as illustrated in FIGS. 2 and 3, the “virtual volume 3” is used only in a case where the channel between the virtualization switch A and the storage device is currently in operation (active path). Specifically, if the host computer sends, to the virtualization switch B, an access request with respect to the “virtual volume 2” (virtual target “WWN: 2”), the virtualization switch B sends the access request received from the host computer to the virtualization switch A only when the channel between the virtualization switch B and the storage device is not currently in operation (passive path). At this time, the virtualization switch B converts the access request (virtual target “WWN: 2”) with respect to the “virtual volume 2” to an access request (inter-switch virtual target “WWN: C1”) with respect to the “virtual volume 3”. Then, the inter-switch access receiving unit 22 in the virtualization switch A receives the access request with respect to the “virtual volume 3” from the virtualization switch B and transfers it to the storage virtualization unit 23.

In contrast, the virtualization switch 100 is assumed to be the virtualization switch B illustrated in FIGS. 2 and 3. As illustrated in FIGS. 2 and 3, the virtualization switch B sets the “virtual volume 4” as an external virtual volume corresponding to the “virtual volume 1” that is set in the virtualization switch A. Furthermore, as illustrated in FIGS. 2 and 3, the “virtual volume 4” is used only in a case where the channel between the virtualization switch B and the storage device is currently in operation (active path). Specifically, if the host computer sends, to the virtualization switch A, an access request (virtual target “WWN: 1”) with respect to the “virtual volume 1”, the virtualization switch A sends the access request received from the host computer to the virtualization switch B only when the channel between the virtualization switch A and the storage device is not currently in operation (passive path). At this time, the virtualization switch A converts the access request (virtual target “WWN: 1”) with respect to the “virtual volume 1” to an access request (inter-switch virtual target “WWN: C2”) with respect to the “virtual volume 4”. Then, the inter-switch access receiving unit 22 in the virtualization switch B receives the access request with respect to the “virtual volume 4” from the virtualization switch A and transfers it to the storage virtualization unit 23.

The storage virtualization unit 23 stores therein configuration information on the virtual volumes configured in the virtualization switch 100. When the storage virtualization unit 23 receives an access request, the storage virtualization unit 23 accesses the real disk volume in the storage device by referring to the configuration information. Specifically, the storage virtualization unit 23 is connected to the access receiving unit 21, the inter-switch access receiving unit 22, and the inter-switch zoning unit 24. Furthermore, when the storage virtualization unit 23 receives an access request transferred from the access receiving unit 21 or from the inter-switch access receiving unit 22, the storage virtualization unit 23 refers to, using the received access request, the configuration information and accesses the real disk volume in accordance with the configuration information. After referring to the configuration information, the storage virtualization unit 23, in some cases, further forwards the access request to the inter-switch zoning unit 24.

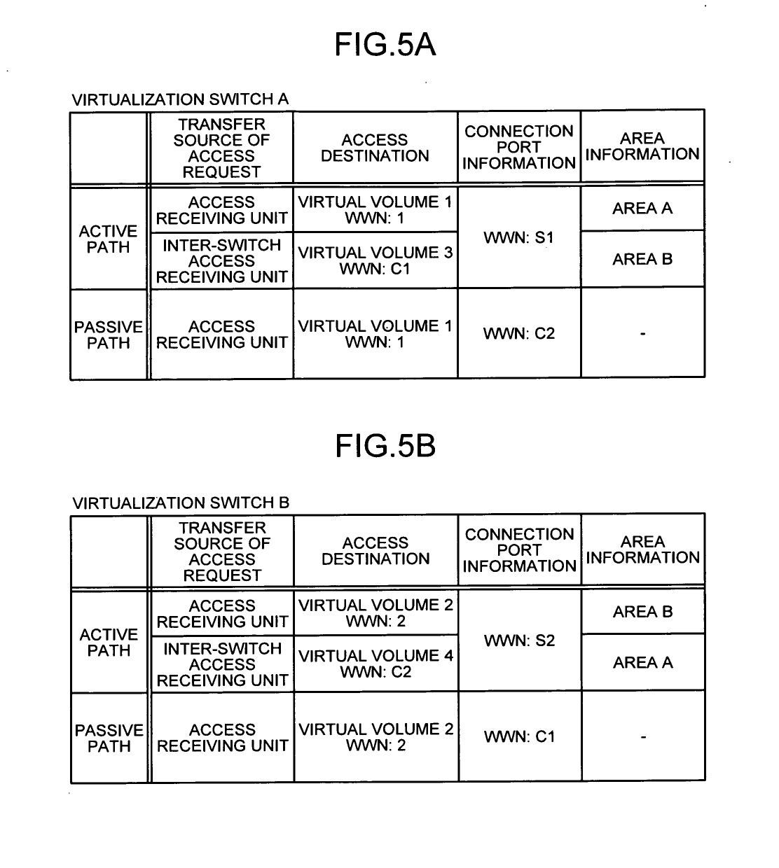

Here, the virtualization switch 100 is assumed to be the virtualization switch A illustrated in FIGS. 2 and 3. At this time, the storage virtualization unit 23 stores therein, for example, configuration information like that illustrated in FIG. 5A. For example, when the storage virtualization unit 23 receives the access request from the access receiving unit 21, the storage virtualization unit 23 detects whether the channel between the virtualization switch A and the storage device is currently in operation (active path). If the channel is in operation (active path), the storage virtualization unit 23 obtains the port “WWN: S1” in the storage device as connection port information and further obtains an “area A” as area information. Then, the storage virtualization unit 23 accesses the storage device via the fiber channel connection port 10-9 to access the area A in the real disk volume, thus implementing an access to the “virtual volume 1” from the host computer.

Furthermore, for example, if the channel is not currently in operation (passive path), the storage virtualization unit 23 obtains the inter-switch virtual target “WWN: C2” as connection port information. Then, the storage virtualization unit 23 further transfers the access request to the inter-switch zoning unit 24.

Furthermore, for example, when the storage virtualization unit 23 receives the access request from the inter-switch access receiving unit 22, the storage virtualization unit 23 obtains the port “WWN: S1” in the storage device as connection port information and further obtains an “area B” as area information. Then, the storage virtualization unit 23 accesses the storage device via the fiber channel connection port 10-9 to access the area B in the real disk volume, thus implementing an access to the “virtual volume 3”. Because the “virtual volume 3” is set as an external virtual volume corresponding to the “virtual volume 2”, the host computer eventually implements an access to “virtual volume 2”.

In contrast, the virtualization switch 100 is assumed to be the virtualization switch B illustrated in FIGS. 2 and 3. At this time, the storage virtualization unit 23 stores therein, for example, configuration information like that illustrated in FIG. 5B. For example, when the storage virtualization unit 23 receives the access request from the access receiving unit 21, the storage virtualization unit 23 detects whether the channel between the virtualization switch B and the storage device is currently in operation (active path). If the channel is in operation (active path), the storage virtualization unit 23 obtains the port “WWN: S2” in the storage device as connection port information and further obtains an “area B” as area information. Then, the storage virtualization unit 23 accesses the storage device via the fiber channel connection port 10-9 to access the area B in the real disk volume, thus implementing an access to “virtual volume 2” from the host computer.

Furthermore, for example, if the channel is not currently in operation (passive path), the storage virtualization unit 23 obtains the inter-switch virtual target “WWN: C1” as connection port information. Then, the storage virtualization unit 23 further transfers the access request to the inter-switch zoning unit 24.

Furthermore, for example, when the storage virtualization unit 23 receives the access request from the inter-switch access receiving unit 22, the storage virtualization unit 23 obtains the port “WWN: S2” in the storage device as connection port information and further obtains an “area A” as area information. Then, the storage virtualization unit 23 accesses the storage device via the fiber channel connection port 10-9 to access the area A in the real disk volume, thus implementing an access to the “virtual volume 4”. Because the “virtual volume 4” is set as an external virtual volume corresponding to the “virtual volume 1”, the host computer eventually implements an access to “virtual volume 1”.

The inter-switch zoning unit 24 transfers an access request to the external virtual volume configured in the other virtualization switch 100. Specifically, the inter-switch zoning unit 24 is connected to the storage virtualization unit 23 and the fiber channel connection port 10. When the inter-switch zoning unit 24 receives an access request transferred from the storage virtualization unit 23, the inter-switch zoning unit 24 converts the destination of the access request to an inter-switch virtual target connected to the external virtual volume and sends the access request to the fiber channel connection port 10.

Here, the virtualization switch 100 is assumed to be the virtualization switch A illustrated in FIGS. 2 and 3. As illustrated in FIGS. 2 and 3, the external virtual volume for the “virtual volume 1” configured in the virtualization switch A is set as the “virtual volume 4” in the virtualization switch B. Furthermore, as has been explained with reference to FIG. 5A, if the channel is not currently in operation (passive path), the storage virtualization unit 23 further transfers the access request to the inter-switch zoning unit 24. Specifically, a case in which the storage virtualization unit 23 transfers the access request to the inter-switch zoning unit 24 means a case in which an access request with respect to the “virtual volume 1” needs to be transferred as an access request with respect to the “virtual volume 4”. Accordingly, the inter-switch zoning unit 24 in the virtualization switch A converts the destination of the access request from the virtual target “WWN: 1” to the inter-switch virtual target “WWN: C2” and sends the access request to the fiber channel connection port 10-16 to which the other virtualization switch 100 is connected.

In contrast, the virtualization switch 100 is assumed to be the virtualization switch B illustrated in FIGS. 2 and 3. As illustrated in FIGS. 2 and 3, the external virtual volume of the “virtual volume 2” configured in the virtualization switch B is set as the “virtual volume 3” in the virtualization switch A. Furthermore, as has been explained with reference to FIG. 5B, if the channel is not currently in operation (passive path), the storage virtualization unit 23 further transfers the access request to the inter-switch zoning unit 24. Specifically, a case in which the storage virtualization unit 23 transfers the access request to the inter-switch zoning unit 24 means a case in which an access request with respect to the “virtual volume 2” needs to be transferred as an access request with respect to the “virtual volume 3”. Accordingly, the inter-switch zoning unit 24 in the virtualization switch B converts the destination of the access request from the virtual target “WWN: 2” to the inter-switch virtual target “WWN: C1” and sends the access request to the fiber channel connection port 10-16 connected to the other virtualization switch 100.

The copying unit 25 copies data stored in the virtual volume in accordance with an instruction from the host computer.

### Flow of a Process of the Virtualization Switch According to Second Embodiment

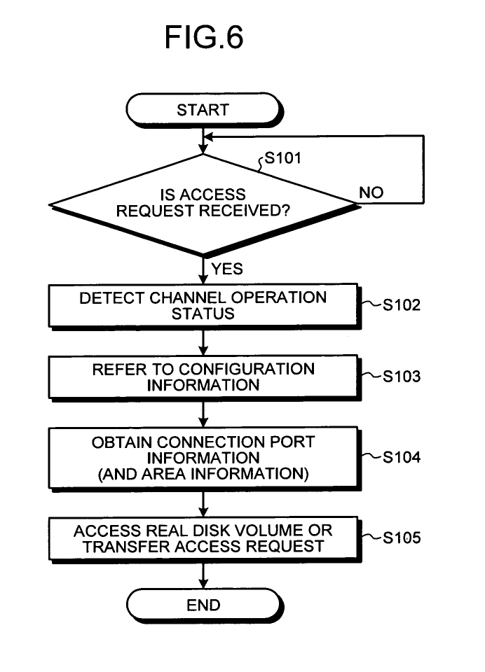

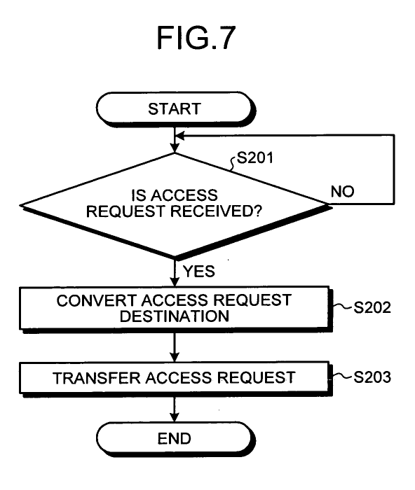

In the following, the flow of a process of the virtualization switch according to the second embodiment will be described with reference to FIGS. 6 and 7. FIG. 6 is a flowchart illustrating the flow performed by the storage virtualization unit. FIG. 7 is a flowchart illustrating the flow performed by the inter-switch zoning unit.

As illustrated in FIG. 6, the storage virtualization unit 23 determines whether to receive an access request (Step S101). If the storage virtualization unit 23 does not receive the access request (No at Step S101), the storage virtualization unit 23 returns to a process for determining whether it receives an access request.

In contrast, if the storage virtualization unit 23 receives an access request (Yes at Step S101), the storage virtualization unit 23 then detects whether the channel between the virtualization switch 100 and the storage device is currently in operation (Step S102).

Thereafter, the storage virtualization unit 23 refers to, in accordance with the detection result obtained at Step S102, the configuration information (Step S103) and obtains the connection port information (Step S104). If the connection port information specifies a port connected to the storage device, the storage virtualization unit 23 obtains area information in addition to the connection port information.

Subsequently, the storage virtualization unit 23 accesses the real disk volume in accordance with the connection port information obtained at Step S104 or transfers the access request (Step S105).

Specifically, if the connection port information obtained at Step S104 specifies the port in the storage device, the storage virtualization unit 23 has already obtained the area information in addition to the connection port information. Accordingly, the storage virtualization unit 23 accesses the storage device via the fiber channel connection port 10 to access a predetermined area in the real disk volume specified by the area information, thus implementing an access to the virtual volume from the host computer. In contrast, if the connection port information obtained at Step S104 does not specify the port in the storage device but specifies the inter-switch virtual target, the storage virtualization unit 23 transfers the access request to the inter-switch zoning unit 24.

In the following, as illustrated in FIG. 7, the inter-switch zoning unit 24 determines whether to receive the access request (Step S201). If the inter-switch zoning unit 24 does not receive the access request (No at Step S201), the inter-switch zoning unit 24 returns to a process for determining whether it receives an access request.

In contrast, if the inter-switch zoning unit 24 receives the access request (Yes at Step S201), the inter-switch zoning unit 24 then converts the destination of the access request (Step S202). Specifically, a case in which the storage virtualization unit 23 transfers the access request to the inter-switch zoning unit 24 means a case in which an access request to the virtual volume configured in its own virtualization switch 100 needs to be transferred. as an access request to the external virtual volume configured in the other virtualization switch 100. Accordingly, the inter-switch zoning unit 24 converts the destination of the access request from the virtual volume in its own virtualization switch 100 to the external virtual volume in the other virtualization switch 100.

Then, the inter-switch zoning unit 24 transfers the access request (Step S203). Specifically, the inter-switch zoning unit 24 transfers the access request to the fiber channel connection port 10 connected to the other virtualization switch 100.

### Advantage of Second Embodiment

As described above, the virtualization switches according to the second embodiment are connected between the host computer and the storage device in a redundant manner and form the communication channels that transfer access requests between the virtualization switches. The virtualization switches each include a virtual volume that is set as a virtual memory area that directly receives an access request from the host computer and a virtual volume that is set as a virtual memory area that receives an access request transferred from the other virtualization switch. If the channel to the storage device is currently in operation, the virtualization switches perform a control in such a manner that the access request is sent to the storage device via the channel. If the channel is not currently in operation, the virtualization switches perform a control in such a manner that the access request is transferred to the other virtualization switch via the communication channel.

In this manner, the storage virtualization system according to the second embodiment transfers access requests, issued to the virtual volume, that are distributed and sent to the virtualization switches using the communication channels formed between the virtualization switches and sends them to the storage device from the virtualization switch whose channel is currently in operation. Accordingly, according to the second embodiment, it is possible to reduce the frequency of switching paths in the storage device, thus improving the performance of the storage virtualization system.

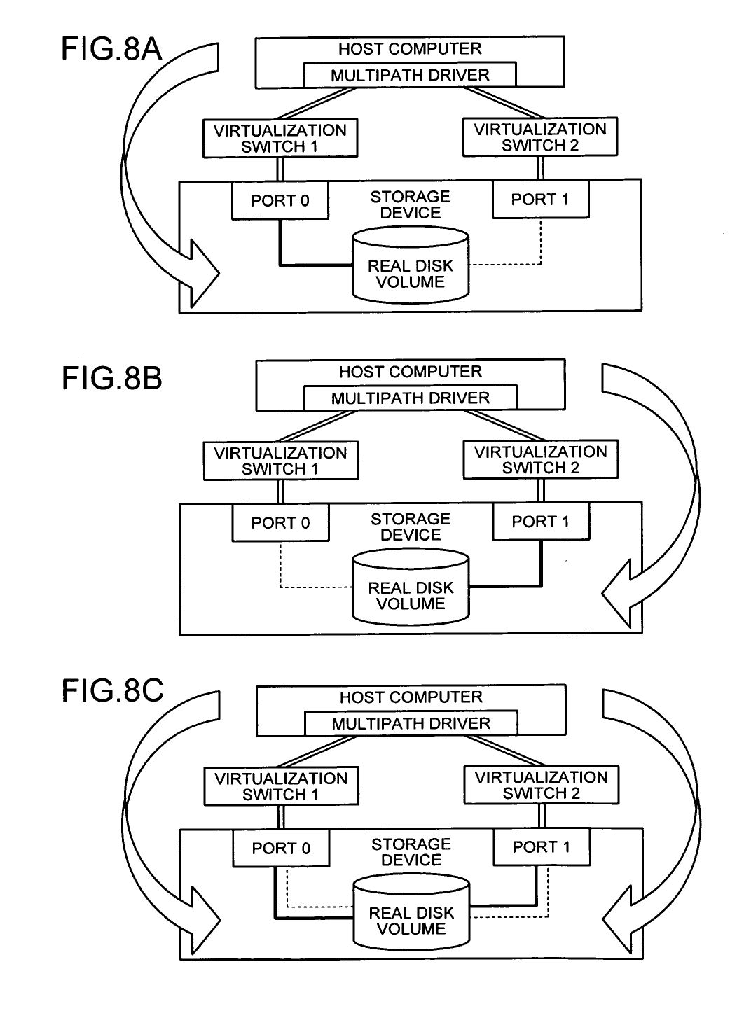

Specifically, in the conventional technology, for example, as illustrated in FIG. 8C, if access requests from the host computer are randomly sent to both paths, a storage device needs to switch the paths by sending an error reply each time. This causes frequent occurrence of error replies, whereby the access requests themselves are sometimes recognized as errors due to the paths being blocked.

However, with the storage virtualization system according to the second embodiment, even when access requests are randomly sent to the virtualization switch from the host computer, the virtualization switches always transfer the access requests to the virtualization switch whose channel is currently in operation. The access requests are sent to the storage device only from the virtualization switch whose channel is in operation. As a result, the storage device does not need to switch paths; therefore, no error reply occurs. Accordingly, it is possible to avoid a blocking state of the paths or a state in which the access requests themselves are recognized as errors.

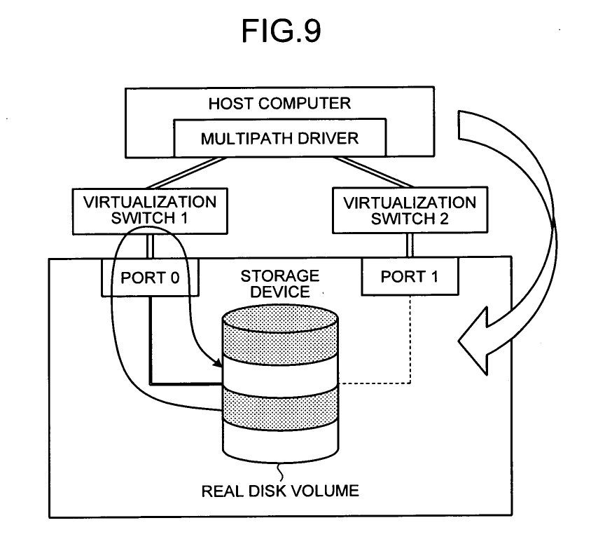

Furthermore, the control is not limited to the multipath control performed by the host computer. For example, as illustrated in FIG. 9, an access request from the host computer is assumed to be sent to the passive path during which the copying unit 25 in the virtualization switch performs copying processing on the storage device using the active path. In the conventional technology, frequent switching of the paths occurs in a storage device, thus a state in which copying processing itself is recognized as an error may possibly occur.

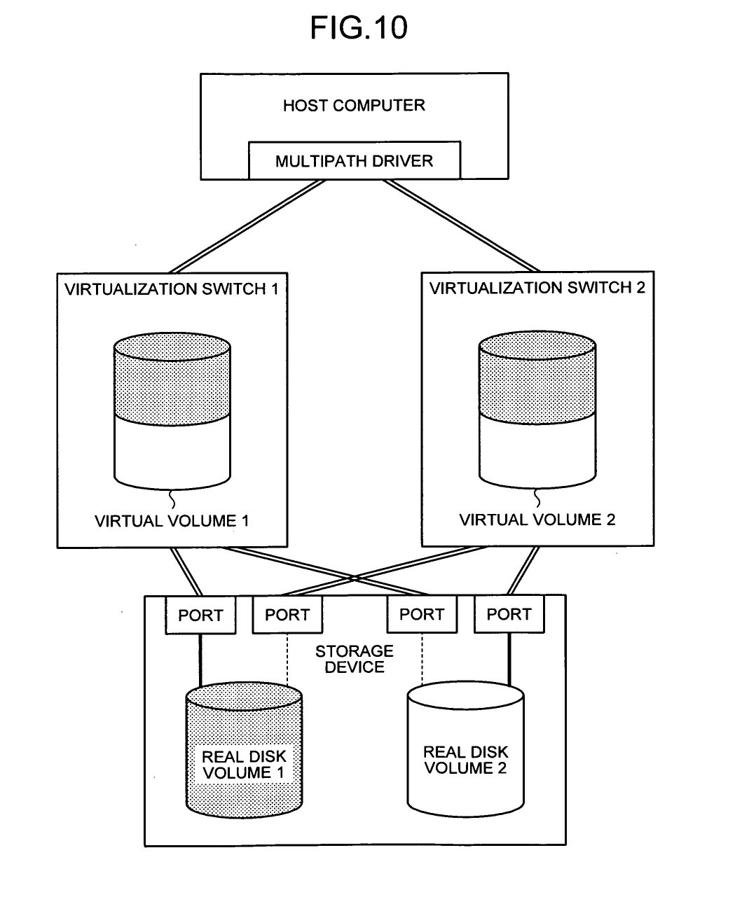

Furthermore, for example, as illustrated in FIG. 10, in virtualization switches, a concatenation-type virtual volume is assumed to be set in which a real disk volume connected to an active path and a real disk volume connected to a passive path are virtually coupled. Specifically, in a virtualization switch 1, a concatenation-type virtual volume is set in which a real disk volume 1 connected to the active path and a real disk volume 2 connected to the passive path are virtually coupled. In contrast, in a virtualization switch 2, a concatenation-type virtual volume is set in which a real disk volume 2 connected to the active path and a real disk volume 1 connected to the passive path are virtually coupled. If access requests from the host computer are sent to a memory area in the real disk volume 1 or to a memory area in the real disk volume 2, with the conventional technology, frequent switching of paths occurs in the storage device, thus a state in which access requests themselves are recognized as errors may possibly occur.

However, with the storage virtualization system according to the second embodiment, even in such a case, the virtualization switches always transfer the access requests to the virtualization switch whose channel is in operation. Because the access requests are sent to the storage device only from the virtualization switch whose channel is currently in operation, the storage device does not need to switch paths. For example, if an access request issued to the memory area in the real disk volume 2 is sent to the virtualization switch 1, the virtualization switch 1 transfers the access request to the virtualization switch 2. The access request is sent to the storage device from the virtualization switch 2 via the active path. As a result, the storage device does not need to switch paths; therefore, no error reply occurs. Accordingly, it is possible to avoid a state in which the copying processing itself is recognized as an error or a state in which the access request themselves are recognized as errors.

### [c] Third Embodiment

The embodiments of the relay device and the relay program disclosed in the present invention have been described; however the embodiments are described only by way of an example. Various modifications and changes can be made in accordance with the knowledge of those skilled in the art.

For example, in the second embodiment described above, a method in which an operation status of the channel between its own virtualization switch and the storage device is detected each time the virtualization switch receives the access request; however, the embodiment is not limited thereto. For example, if a predetermined channel is determined, in advance, to be a current use channel, the virtualization switch usually simply controls access requests in accordance with the configuration information about the current use channel. At this time, the access request is suspended by the virtualization switch only after the failure that occurs in the current use channel is detected. Then, the virtualization switch switches the paths in accordance with the configuration information about a queued channel and resumes the access request. At this time, if information (e.g., failure detection information, etc.) needs to be exchanged between the virtualization switches, the information can be sent, for example, via an external connection port.

Furthermore, for example, if the channel to the storage device is currently in operation, the access request is controlled in such a manner that the access request is sent to the storage device via that channel. If the channel is not in operation, the control process for transferring the access request to the other virtualization switch via the communication channel can be performed by a virtualization switch as a relay program.

According to an aspect of a relay device and a relay program disclosed in the present invention, it is possible to reduce the frequency of switching paths in a storage device, thus improving the performance of a storage virtualization system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device connected between a host computer and a storage device, the relay device being configured to allocate, using a real memory area included in the storage device, a virtual memory area to the host computer, and to process an access request to the virtual memory area, and the relay device comprising:
a port connected to a communication channel for transferring and receiving an access request to and from another relay device;
a first virtual area section set as a virtual memory area for receiving an access request from the host computer;
a second virtual area section connected to the communication channel via the port and set as a virtual memory area for receiving an access request transferred from the another relay device; and
a control unit that sends, if a channel to the storage device is in operation, the access request that is sent to the first virtual area section and the access request that is transferred to the second virtual area section, to the storage device via the channel, the control unit transferring, if the channel is not in operation, the access request that is sent to the first virtual area section, to the another relay device via the communication channel that is connected to the port.

2. A computer readable storage medium having stored therein a replay program for a relay device connected between a host computer and a storage device, the relay device being configured to allocate, using a real memory area included in the storage device, a virtual memory area to the host computer, and to process an access request to the virtual memory area, and the relay device comprising a port connected to a communication channel for transferring and receiving an access request to and from another relay device, a first virtual area section set as a virtual memory area for receiving an access request from the host computer, a second virtual area section connected to the communication channel via the port and set as a virtual memory area for receiving an access request transferred from the another relay device, the replay program causing the relay device to execute a process comprising:
sending, if a channel to the storage device is in operation, the access request that is sent to the first virtual area section and the access request that is transferred to the second virtual area section, to the storage device via the channel; and
transferring, if the channel is not in operation, the access request that is sent to the first virtual area section, to the another relay device via the communication channel that is connected to the port.
